(19) United States
(12) Patent Application Publication
(10) Pub. No.: US 2026/0097717 A1
(43) Pub. Date: Apr. 9, 2026

(54) FIRST COMPONENT TO BE CONNECTED TO A SECOND COMPONENT TO FORM A COMPONENT ASSEMBLY, COMPONENT ASSEMBLY COMPRISING SUCH A FIRST COMPONENT AND SUCH A SECOND COMPONENT, AND A METHOD FOR PROVIDING SUCH A COMPONENT ASSEMBLY

(71) Applicant: HELLA GMBH & CO. KGAA, Lippstadt (DE)

(72) Inventors: Thomas Herbers, Lippstadt (DE); Fabian Thon, Lippstadt (DE)

(21) Appl. No.: 19/351,738

(22) Filed: Oct. 7, 2025

(30) Foreign Application Priority Data
Oct. 8, 2024 (DE) 102024128953.8

(51) Int. Cl. B60R 11/00

(52) U.S. Cl. CPC B60R 11/00; B60R 2011/0047

(57) ABSTRACT

The present invention relates to a first component that is to be connected to a second component to form a component assembly, including a base body with a receiving portion, and a positioning element that is connectable to the base body. The positioning element has a fastening portion that is insertable into the receiving portion for form-fitting, material-bonded, or force-fitted connection of the positioning element to the base body. The positioning element includes a latching portion insertable into an opening or a recess of the second component. The positioning element further includes an intermediate portion which connects the receiving portion and the latching portion to one another. The intermediate portion has a higher elasticity than the fastening portion when the latter is inserted into the receiving portion. The present invention further relates to such a component assembly and to a method for providing such a component assembly.

### CROSS-REFERENCE TO RELATED APPLICATIONS

The present application claims priority to German Patent Application DE 10-2024-128-953.8, filed Oct. 8, 2024, the disclosure of which is incorporated by reference.

### FIELD OF THE INVENTION

The present invention relates to a first component which is to be connected to a second component to form a component assembly. Furthermore, the invention relates to a component assembly comprising such a first component and such a second component, a vehicle with such a component assembly, and a method for providing such a component assembly.

### BACKGROUND OF THE INVENTION

When two components are to be joined together to form an assembly or a component assembly, it is often necessary to position the two components as precisely as possible relative to each other for both technical and visual reasons. This is the only way to ensure that, for example, a surface of the first component merges into the surface of the second component without offset and/or that gap dimensions are maintained.

In many cases, screws are used to connect the two components to one another. However, it is well known that screws are not suitable for positioning components connected in this way. For this reason, positioning pins are often used that are arranged on the first component and engage in positioning pin receptacles on the second component, or vice versa. However, the positioning pins are only used for positioning, not for fastening the two components. In this respect, two different elements, namely positioning pins and screws, must be used to connect the two components to one another as desired. Depending on the installation position, the positioning pin of the first component may move out of the positioning pin receptacle of the second component after positioning and before connecting with the screws, until the screws are attached and engaged. This makes installation more difficult.

It is known to provide positioning pins with a latching function so that the first component is also connected to the second component in a latching manner during positioning. The disadvantage of this is that the latched connection is difficult to release if, for example, one of the two components needs to be replaced. Although positioning pins with a latching function can also be made of metal, they are usually made of plastic, particularly for cost reasons, so that the choice of materials is limited. In addition, positioning pins require a certain amount of installation space in order to be sufficiently attached to the respective component. However, the required installation space is not always available, for example, in sheet metal parts.

In particular, components that are manufactured in large quantities can only be produced with certain tolerances. While one of the first components can easily be brought into the intended nominal position relative to the second component, this may not be the case with another first component, even though this first component is within the tolerances. However, it must still be possible to make a fine adjustment after fastening in order to bring the first component into the nominal position relative to the second component. Slotted holes can be provided for this purpose, within which a certain amount of subsequent correction is possible, but this is a time-consuming process.

### SUMMARY OF THE INVENTION

The object of one embodiment of the present invention is to provide a first component that is to be connected to a second component to form a component assembly, which makes it possible to overcome the above-mentioned disadvantages with simple and cost-effective means. In particular, it should be possible to connect the first component to the second component quickly and easily, even with more generous tolerances. A further object of an embodiment of the present invention is to provide a component assembly with such a first component and such a second component. In addition, an object of an embodiment of the invention is to provide a vehicle with such a component assembly and to specify a method for providing such a component assembly.

This object is achieved by the features specified herein. Advantageous embodiments are described in the dependent claims.

One embodiment of the invention relates to a first component, which is to be connected to a second component to form a component assembly, comprising: a base body with a receiving portion; and a positioning and/or connecting element that can be connected to or is connected to the base body, and which has a fastening portion that can be inserted or is inserted into the receiving portion for a form-fitting, material-bonded or force-fitted connection of the connecting element to the base body, a latching portion which can be inserted into an opening or a recess of the second component for positioning the second component relative to the first component and/or for form-fitting and/or force-fitted connection of the first component to the second component, and an intermediate portion which connects the receiving portion and the latching portion to each other, the intermediate portion having a higher elasticity than the fastening portion when the latter is inserted into the receiving portion.

The term “positioning and/or connecting element” can be understood to mean that the first component can be pre-positioned when being connected to the second component and remains in this pre-position. Depending on the embodiment, this pre-position may already be the desired position of the first component relative to the second component. As mentioned, the positioning and/or connecting element holds the first component in a certain position relative to the second component. Depending on the load to which the first component and the second component are subjected during operation of the component assembly, the connection provided in this way may already be sufficient. If this is not the case, the first component can be attached to the second component using additional fastening means, for example, screws. Therefore, depending on the application, the proposed positioning and/or connecting element may have not only a positioning effect, but also a connecting effect.

The positioning and/or connecting element has three portions, namely the fastening portion, the intermediate portion and the latching portion, whereby the intermediate portion has a higher elasticity at least compared to the fastening portion. The different elasticity can be adjusted, for example, by increasing the wall thickness of the fastening portion. Due to the elasticity, the first component can also be detached from the second component, for example, if the first component needs to be replaced.

According to a further embodiment, the latching portion may have a V-shaped projection with a first leg and a second leg, the second leg pointing toward the free end of the connecting element or forming the same, and forming an insertion slope. The insertion slope ensures a certain degree of pre-positioning so that the projection can be inserted into the opening or recess simply by pushing the first component toward the second component. This keeps installation simple. Moreover, installation can be carried out quickly.

In a further embodiment, the connecting element may be made of metal, and the fastening portion can be formed by means of one or more helical windings. The helical windings give the fastening portion at least approximately a cylindrical shape, so that the fastening portion can be inserted into a correspondingly complementary-shaped receiving section. This can create a force-fitted connection between the receiving portion and the fastening portion, whereby the positioning and/or connecting element can be fastened to the base body of the first component. The elastic intermediate portion may project into the cylindrical section so that part of the elasticity is provided by the windings, provided that these can move relative to the receiving portion.

In a further embodiment, the latching portion may have a bent portion at its free end. A bent portion prevents the positioning and/or connecting element from damaging and, in particular, scratching the second component when the first component is pushed forward, or the positioning and/or connecting element from getting stuck in the second component.

One embodiment of the invention relates to a component assembly comprising: a first component according to one of the previous embodiments; a second component which has an opening or a recess, wherein the first component and the second component are positioned relative to one another and/or connected to one another in that the latching portion of the first component engages in a form-fitting and/or force-fitted manner in the opening or recess of the second component.

The technical effects and advantages that can be achieved with the proposed component assembly essentially correspond to those discussed for the present first component. In summary, it should be noted that the first component can be brought into the desired position relative to the second component simply by pushing it toward the second component. The component assembly can therefore be provided quickly and easily.

In a further embodiment, it may be provided that: the first component has a reference surface for positioning the first component and the second component relative to each other, and the first leg of the V-shaped projection is designed such that it exerts a positioning force on the second component when it engages in the opening or recess, wherein the reference surface and the first leg are arranged and designed in such a way that the positioning force acts at least partially perpendicularly to the reference surface.

When the second component is in contact with the reference surface, the first component and the second component have the desired position relative to each other. As mentioned, the first component is pushed toward the second component for connection, with the V-shaped projection engaging in the opening or recess of the second component. The first leg engages in the opening or recess at a certain inclination, whereby the first leg exerts a force on the second component directed toward the reference surface, where it comes into contact with the second component. As a result, the second component is moved by the positioning and/or connecting element toward the reference surface, so that the second component comes into contact there and is positioned as desired.

Due to the increased elasticity of the intermediate portion, the V-shaped projection applies the force to the second component, at least within certain limits, even when the second component is not in the nominal position, particularly parallel to the reference surface, due to manufacturing inaccuracies. In this respect, the positioning and/or connecting element also ensures the desired positioning of the first component relative to the second component, in this case, without the need for a time-consuming readjustment.

An advanced embodiment may provide that: the first component has two positioning and/or connecting elements connected to the base body and a positioning pin or a positioning pin receptacle; or the first component has a positioning and/or connecting element connected to the base body and two positioning pins or two positioning pin receptacles.

In this embodiment, three referencing points are created at which the first component is positioned relative to the second component. The position of the first component relative to the second component is therefore clearly defined. The use of at least one positioning pin has proven to be expedient in that it allows the position of the first component relative to the second component to be fixed parallel to the reference surface.

According to an advanced embodiment, the first component and the second component may be connected to each other by fastening means. As mentioned, the positioning and/or connecting elements also provide fastening of the first component to the second component to a limited extent. Depending on the load acting on the component assembly created in this way, however, it may be necessary to create an additional fastening by fastening means, for example, with screws. However, these serve only to attach the first component to the second component and do not influence the position of the first component relative to the second component.

According to a further embodiment, the first component may be a headlamp or a trim component of a vehicle, and the second component may be the body of the vehicle. In vehicle construction, a challenge is to produce vehicles in a short time with little effort and a high degree of precision. The use of the proposed component assembly in vehicle construction fulfills these requirements to a greater extent. Headlamps and trim components are particularly suitable for being designed in line with the proposal.

An embodiment of the invention relates to a vehicle comprising a component assembly according to one of the previously discussed embodiments. The use of the proposed component assembly in vehicle construction fulfills the aforementioned requirements to a greater extent.

An embodiment of the invention relates to a method for providing a component assembly according to one of the previously presented embodiments, comprising the following steps: providing a first component and a second component; and moving the first component relative to the second component such that the latching portion of the first component is inserted into the opening or recess of the second component to position them relative to each other.

The technical effects and advantages that can be achieved with the proposed method are essentially the same as those discussed for the first component. In summary, it should be noted that the first component can be brought into the desired position relative to the second component simply by pushing it toward the second component. The component assembly can therefore be provided quickly and easily.

In a further embodiment, the first component and the second component may be fastened to each other by fastening means. As mentioned, the positioning and/or connecting elements also provide fastening of the first component to the second component to a limited extent. Depending on the load acting on the component assembly created in this way, however, it may be necessary to create an additional fastening by fastening means, for example, with screws. However, these serve only to attach the first component to the second component and do not affect the position of the first component relative to the second component once set.

### BRIEF DESCRIPTION OF THE DRAWINGS

Exemplary embodiments of the invention are explained in more detail below with reference to the accompanying drawings. In the figures:

FIG. 1A shows a first embodiment of a component assembly according to the invention, comprising a first component and a second component;

FIG. 1B shows the first embodiment of the component assembly shown in FIG. 1 by means of a sectional view along the sectional plane A-A defined in FIG. 1A;

FIG. 2 is an illustration of the component assembly analogous to FIG. 1B, but with the second component shown in three positions;

FIG. 3A is a schematic top view of a second embodiment of a component assembly;

FIG. 3B is a schematic side view of the component assembly shown in FIG. 3A; and

FIG. 4 is a schematic representation of a vehicle equipped with a component assembly according to the invention.

### DETAILED DESCRIPTION OF THE CURRENT EMBODIMENTS

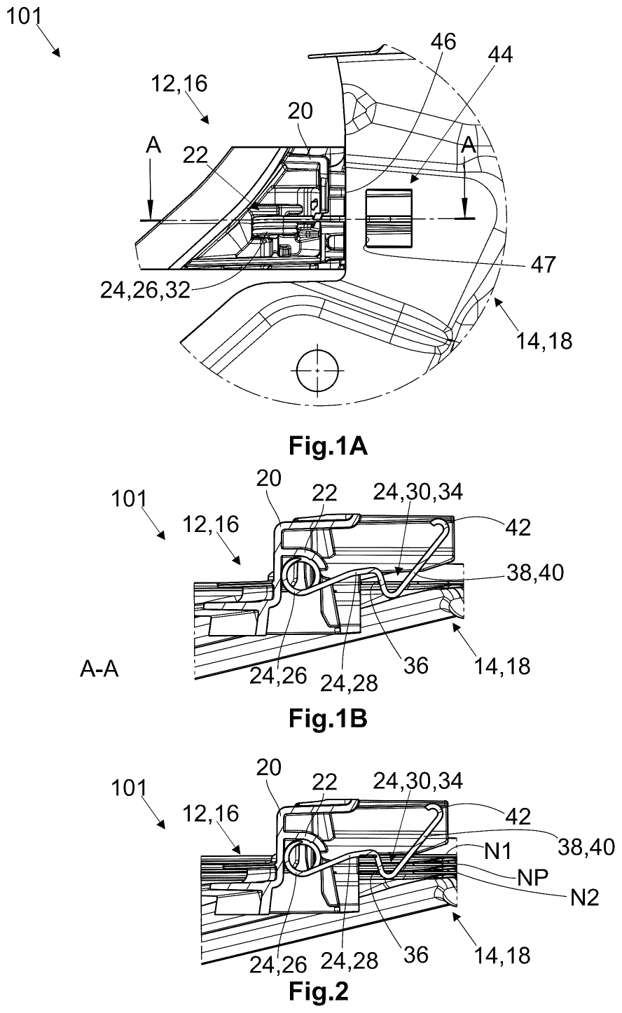

FIGS. 1A and 1B show a first embodiment of a component assembly 101 according to the invention. The component assembly 101 is formed by a first component 12 and a second component 14. In the embodiment shown, the first component 12 is designed as a headlamp 16 or a trim component 15 and the second component 14 is designed as the body 18 of a vehicle 19 (see FIG. 4).

The first component 12 has a base body 20, which is provided with a receiving portion 22. In addition, a positioning and/or connecting element 24 is provided, which is made of a metal, for example, steel, and may have a circular cross-sectional area, although differently shaped cross-sectional areas are also possible. The positioning and/or connecting element 24 forms a fastening portion 26, an intermediate portion 28, and a latching portion 30 (see in particular FIG. 1B).

The fastening portion 26 is formed by a number of helical windings 32, which give the fastening portion 26 at least approximately the external shape of a cylinder. As can be seen in particular from FIG. 1B, the fastening portion 26 can be inserted into the receiving portion 22 of the first component 12, for which purpose the receiving portion 22 is provided at least in sections with a shape that is complementary to the fastening portion 26. The receiving portion 22 can be provided with a certain reversible deformability, so that when the fastening portion 26 is inserted into the receiving portion 22, a force-fitted connection is created, by which the positioning and/or connecting element 24 is fastened to the base body 20.

The latching portion 30 of the positioning and/or connecting element 24 is designed as a V-shaped projection 34 with a first leg 36 and a second leg 38. The first leg 36 points toward the fastening portion 26, while the second leg 38 points toward the free end of the positioning and/or connecting element 24. The second leg 38 forms an insertion slope 40, the function of which will be discussed in more detail later. At the free end, the positioning and/or connecting element 24 is provided with a bent portion 42, also referred to as a bend.

The intermediate portion 28 is arranged between the fastening portion 26 and the latching portion 30. The intermediate section 28 is designed in such a way that it has an elasticity that is higher than that of the fastening portion 26 as a whole.

As mentioned, the second component 14 is designed as a body 18 of a vehicle 19. The part of the body 18 shown here is a sheet metal part which has an opening 44. Depending on the configuration of the second component 14, however, a recess or a stop may also be provided, with which the latching portion 30 of the positioning and/or connecting element 24 can interact with the second component 14. In the embodiment shown, however, the V-shaped projection 34 engages in the aforementioned opening 44 of the second component 14.

The first component 12 has a reference surface 46. When the second component 14 is in contact with the reference surface 46, the first component 12 and the second component 14 are in the desired position relative to each other. To position the first component 12 relative to the second component 14, proceed as follows: The first component 12 is moved toward the second component 14, so that first the insertion slope 40 comes into contact with the front edge of the second component 14, and, as the first component 12 is advanced further toward the second component 14, the positioning and/or connecting element 24 is lifted with reference to the representation in FIG. 1B, the elasticity required for this being provided by the intermediate portion 28 or by the intermediate portion 28 together with the adjacent winding of the fastening portion 26. However, it is also possible to make the fastening portion 26 “rigid” in this respect. The bent portion 42 prevents scratching and/or blocking of the positioning and/or connecting element 24 in the second component 14.

The first component 12 is then moved further toward the second component 14 until the V-shaped projection 34 engages in the opening 44 of the second component 14, as can be clearly seen in FIG. 1B. The first leg 36 thereby comes into contact with a bearing edge 47 of the opening 44 (see FIG. 1A), wherein the bearing edge 47 and the latching portion 30 are designed such that a force is thereby exerted by the latching portion 30 on the second component 14, which force is reported at least partially perpendicularly to the reference surface 46. As a result, the first component 12 is pulled toward the second component 14, and the second component 14 comes into contact with the reference surface 46, as shown in FIG. 1A and FIG. 1B. The first component 12 and the second component 14 are now positioned relative to each other as desired.

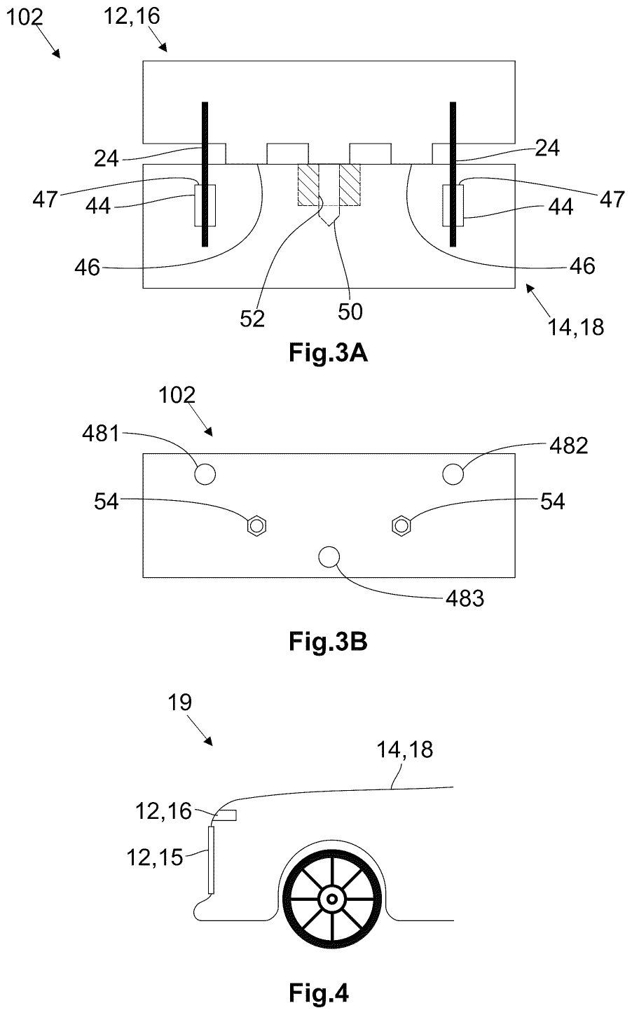

Due to the force exerted by the positioning and/or connecting element 24 on the second component 14, not only positioning but also attachment of the first component 12 to the second component 14, to a certain extent, is provided. Depending on the area of application, this fastening may be sufficient. In most cases, however, only pre-positioning is effected, and the actual connection is made by fastening means 54 (see FIG. 3B), in particular by screws, which are subsequently mounted.

FIG. 2 shows the component assembly 101 analogous to FIG. 1B, but here the second component 14 is shown in three positions, namely in the nominal position NP, a first position N1 located above the nominal position NP in relation to the representation selected in FIG. 2, and in a second position N2 located below the nominal position NP. The first position N1 and the second position N2 may result from manufacturing inaccuracies which are, however, within the tolerance. In particular, due to the elasticity of the positioning and/or connecting element 24, the above-mentioned pre-positioning, and in particular the contact of the second component 14 with the reference surface 46 of the first component 12, can also be achieved when the second component 14 is in the first position N1 or the second position N2 relative to the first component 12. For this purpose, the course of the first leg 36 in particular, and the transition of the first leg 36 into the intermediate portion 28, and the elasticity of the intermediate portion 28 in particular, are selected such that not only in the nominal position NP, but also in the first position N1 and the second position N2, the latching portion 30 applies a sufficiently large force to the bearing edge 47 of the second component 14 in order to ensure that the second component 14 bears against the reference surface 46.

FIG. 3A shows a schematic top view of a second embodiment, and FIG. 3B shows a schematic side view of the second embodiment of the component assembly 102 according to the invention shown in FIG. 3A. In particular, it can be seen from FIG. 3B that a total of three referencing points are provided, namely a first referencing point 481, a second referencing point 482, and a third referencing point 483, at which the first component 12 and the second component 14 can be positioned relative to one another. At the first referencing point 481 and the second referencing point 482, the first component 12 and the second component 14 each have a positioning and/or connecting element 24 and an opening 44, as previously described. At the third referencing point 483, the first component 12 is provided with a positioning pin 50, which can engage in a positioning pin receptacle 52 of the second component 14. Each referencing point 481, 482, 483 is assigned its own reference surface 46, which may well be arranged at some distance from the relevant positioning and/or connecting element 24 or from the positioning pin 50.

The positioning of the first component 12 relative to the second component 14 is carried out in a largely identical manner as described for the first embodiment, with the difference that when the first component 12 is advanced toward the second component 14, the positioning pin 50 engages in the positioning pin receptacle 52. While the positioning and/or connecting elements 24 provide fixation perpendicular to the reference surfaces 46, the positioning pin 50 provides fixation parallel to the reference surfaces 46. In an embodiment not shown, the positioning pin 50 may provide fixation both perpendicular and parallel to the reference surfaces 46.

In particular, it can be seen from FIG. 3B that the third referencing point 483 is not located on a connecting line (not shown) connecting the first referencing point 481 and the second referencing point 483, but is spaced apart therefrom. The position of the first component 12 is thus fixed at three referencing points 481, 482, 483 relative to the second component 14 in a statically determined manner.

As can also be seen from FIG. 3B, only pre-positioning of the first component 12 relative to the second component 14 is effected with the positioning and/or connecting elements 24 and the positioning pin 50, while the actual connection is realized with fastening means 54, here with screws.

FIG. 4 shows a vehicle 19, which may be equipped with a component assembly 101, for example, according to the first embodiment. In this case, the first component 12 is a trim component 15, for example, a radiator grille which may be illuminated, and a headlamp 16, while the second component 14 is the body 18 of the vehicle 19.

### LIST OF REFERENCE NUMBERS

101, 102 component assembly
12 first component
14 second component
16 headlamp
15 trim component
18 body
19 vehicle
20 base body
22 receiving portion
24 positioning and/or connecting element
26 fastening portion
28 intermediate portion
30 latching portion
32 winding
34 projection
36 first leg
38 second leg
40 insertion slope
42 bent portion
44 opening
46 reference surface
47 bearing edge
481, 482, 483 referencing point
50 positioning pin
52 positioning pin receptacle
54 fastening means
NP nominal position
N1 first position
N2 second position

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A first component to be connected to a second component to form a component assembly, the first component comprising:
a base body with a receiving portion; and
a positioning element connectable to the base body, which includes:
a fastening section insertable into the receiving portion for form-fitting, material-bonded, or force-fitted connection of the positioning element to the base body,
a latching portion insertable into an opening or a recess of the second component for positioning the second component relative to the first component or for form-fitting or force-fitted connection of the first component to the second component, and
an intermediate portion connectable to the receiving portion and the latching portion to one another, the intermediate portion having a higher elasticity than the fastening portion when the latter is inserted into the receiving portion.

2. The first component according to claim 1, wherein the latching portion has a V-shaped projection with a first leg and a second leg, the second leg pointing toward a free end of the positioning element or forming the same, and the second leg forming an insertion slope.

3. The first component according to claim 1, wherein the positioning element is made of metal or the fastening portion is formed by one or more helical windings.

4. The first component according to claim 3, wherein the latching portion has a bent portion at a free end.

5. A component assembly comprising:
a first component according to claim 2,
a second component which has an opening or a recess, and
wherein the first component and the second component are connected to one another in that the latching portion of the first component engages in the opening or recess of the second component in a form-fitting or force-fitted manner.

6. The component assembly according to claim 5, wherein:
the first component has a reference surface for positioning the first component and the second component relative to each other;
the first leg of the V-shaped projection is configured such that it exerts a positioning force on the second component when the first leg engages in the opening or recess; and
the reference surface and the first leg are arranged and configured such that the positioning force acts at least partially perpendicularly to the reference surface.

7. The component assembly according to claim 5,
wherein the first component has:
two positioning elements connected to the base body; and
a positioning bolt or a positioning bolt receptacle; or
wherein the first component has:
one positioning element connected to the base body; and
two positioning pins or two positioning pin receptacles.

8. The component assembly according to claim 5, wherein the first component and the second component are connected to one another by a fastener.

9. The component assembly according to claim 5, wherein the first component is a headlamp or a trim component of a vehicle, and the second component is a body of the vehicle.

10. A vehicle comprising a component assembly according to claim 5.

11. A method for providing a component assembly according to claim 5, comprising the following steps:
providing a first component and a second component, and
moving the first component relative to the second component such that the latching portion of the first component is inserted into the opening or the recess of the second component for positioning them relative to each other.

12. The method according to claim 11, wherein the first component and the second component are fastened to one another by a fastener.
